(19) United States
(12) Patent Application Publication
(10) Pub. No.: US 2021/0209468 A1
(43) Pub. Date: Jul. 8, 2021

(54) LEARNING DEVICE, INFERENCE DEVICE, METHOD, AND PROGRAM

(71) Applicant: Mitsubishi Electric Corporation, Tokyo (JP)

(72) Inventors: Daisaku MATSUMOTO, Tokyo (JP); Osamu NASU, Tokyo (JP); Toshisada MARIYAMA, Tokyo (JP)

(73) Assignee: Mitsubishi Electric Corporatio, Tokyo (JP)

(21) Appl. No.: 17/059,536

(22) PCT Filed: Jun. 5, 2018
(86) PCT No.: PCT/JP2018/021488

§ 371 Date: Nov. 30, 2020

(51) Int. Cl. G06N 3/08; G06K 9/62

(52) U.S. Cl. CPC G06N 3/08; G06K 9/6227

(57) ABSTRACT

A training device (100) performs training using a neural network. A training condition acquirer (110) of the training device (100) acquires training conditions that indicate prerequisites of the training. A model selector (150) selects, in accordance with the training conditions, a learning model that serves as a framework of a structure of the neural network. A learning model scale determiner (160) determines, in accordance with the training conditions, a scale of the neural network for the selected learning model. A trainer (170) perform training by inputting training data into the neural network in which the selected learning model is configured to the determined scale.

### TECHNICAL FIELD

The present disclosure relates to a training device, an inference device, a method, and a program.

### BACKGROUND ART

Carrying out deep learning, which is one method of machine learning, needs setting of training parameters in accordance with a purpose, the characteristics of the training data, and the like. However, appropriately setting the training parameters, including selecting a learning model, determining the scale of the neural network, and the like, is not easy for a user that is not knowledgeable about neural networks, artificial intelligence (AI), and the like. Therefore, it is difficult for such a user to perform deep learning.

In an authentication device described in Patent Literature 1 that performs individual authentication on the basis of writing information, the individual authentication is performed using a neural network assigned to a category of the writing information that is the recognition subject.

### CITATION LIST

### Patent Literature

Patent Literature 1: Unexamined Japanese Patent Application Publication No. 2002-175515

### SUMMARY OF INVENTION

### Technical Problem

The authentication device described in Patent Literature 1 simply uses, among a plurality of neural networks, a neural network that is assigned to the category of the recognition subject. Furthermore, the number of layers of the plurality of neural networks is the same as the number of nodes or the like of each layer. In other words, each neural network has the same scale. Consequently, when, for example, changing the scale of the neural network, the user needs to determine the scale on their own. As such, it is difficult for a user that is not knowledgeable about neural networks, AI, and the like to appropriately operate the authentication device described in Patent Literature 1.

The present disclosure is made with the view of the above situation, and an objective of the present disclosure is to enable the setting of appropriate training parameters without the user being aware of the settings of the training parameters.

### Solution to Problem

To achieve the above objective, a training device of the present disclosure performs training using a neural network. Training condition acquisition means acquire training conditions that indicate prerequisites of the training. Learning model selection means select, in accordance with the training conditions, a learning model that serves as a framework of a structure of the neural network. Learning model scale determination means determine, in accordance with the training conditions, a scale of the neural network for the selected learning model. Training means perform training by inputting training data into the neural network in which the learning model is configured to the scale.

### Advantageous Effects of Invention

In accordance with training conditions, the training device of the present disclosure selects a learning model that serves as the framework of the structure of a neural network and determines the scale of the neural network for the selected learning model. Providing the training device of the present disclosure with such a configuration enables the setting of appropriate training parameters without the user being aware of the setting of the training parameters.

### BRIEF DESCRIPTION OF DRAWINGS

FIG. 1 is a block diagram illustrating a hardware configuration of a training inference device according to an embodiment;

FIG. 2 is a functional block diagram of the training inference device according to the embodiment;

FIG. 3 is a drawing illustrating an example of an input screen for an inference purpose according to the embodiment;

FIG. 4 is a drawing illustrating an example of an input screen for restrictions on hardware resources according to the embodiment;

FIG. 5 is a drawing illustrating an example of an input screen for characteristics of training data according to the embodiment;

FIG. 6 is a drawing illustrating an example of an input screen for a training end condition according to the embodiment:

FIG. 7 is a drawing illustrating an example of data stored in a selection table according to the embodiment:

FIG. 8 is a drawing illustrating an example of a change of the learning model according to the embodiment;

FIG. 9 is a drawing illustrating an example of a screen that indicates training progress before the start of training, according to the embodiment:

FIG. 10 is a drawing illustrating an example of a screen that indicates the training progress when the training is interrupted, according to the embodiment:

FIG. 11 is a drawing illustrating an example of a screen that indicates the training progress when the training is ended, according to the embodiment:

FIG. 12 is a flowchart of training processing according to the embodiment, and

FIG. 13 is a flowchart of inference processing according to an embodiment.

### DESCRIPTION OF EMBODIMENTS

Hereinafter, a training inference device 1000 according to embodiments of the present disclosure is described with reference to the drawings.

### EMBODIMENTS

A training inference device 1000 according to the present embodiment automatically determines appropriate training parameters on the basis of information that indicates prerequisites and restrictions related to training that are specified by a user. In this case, the training parameters include a learning model representing the structure of the neural network, the scale of the neural network, a training rate, an activation function, a bias value, and the like.

Specifically, in the present embodiment, the training inference device 1000 automatically determines, from among the training parameters and on the basis of the information that indicates prerequisites and restrictions related to training that are specified by the user, the learning model representing the structure of the neural network and the scale of the neural network.

The training inference device 1000 selects the learning model and expands or shrinks the scale of the neural network for the selected learning model to obtain a deep learning neural network changed to an optimal configuration, and uses this neural network to execute deep learning. The training inference device 1000 performs inference based on training results of the deep learning and data to be inferred.

Here, the term “deep learning” refers to a learning method that uses a multi-layer neural network. The term “multi-layer neural network” refers to a neural network that includes a plurality of intermediate layers positioned between an input layer and an output layer. Hereinafter, the multi-layer neural network is sometimes referred to as a deep neural network. In deep learning, a learning model is presumed, training data is input into a neural network that realizes the presumed learning model, and weighting of the nodes of the intermediate layers of the neural network are modified such that the output of the neural network approaches a true value obtained in advance. Thus, the deep neural network is trained with the relationship between the input and the output.

The deep neural network that has been trained is used in inference. The term “inference” refers to estimating using a trained deep neural network. In the inference, data to be inferred is input into the trained network, and a value output by the trained deep neural network is set as an inference value with respect to the input.

The training inference device 1000 performs training and inference in a production system, a control system, or the like for quality inspection, abnormality cause estimation, device failure prediction, and the like. In one example, the training data provided to the training inference device 1000 is data collected over a given period in the past from various devices such as programmable logic controllers and intelligent functional units that operate in production systems, control systems, and the like, and sensors provided in facilities.

Furthermore, the training inference device 1000 performs inference by the trained deep neural network for quality inspection, abnormality cause estimation, device failure prediction, and the like. In one example, the data to be inferred that is provided to the training inference device 1000 is data collected from various devices such as programmable logic controllers, intelligent functional units, and sensors provided in facilities.

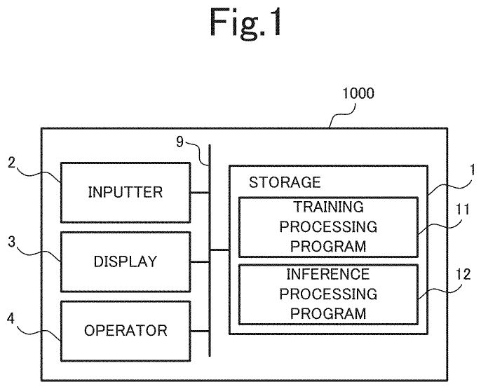

As illustrated in FIG. 1, the training inference device 1000 has a hardware configuration that includes a storage 1 that stores various types of data, an inputter 2 that detects an input operation performed by a user, a display 3 that outputs an image to a display device, and an operator 4 that controls the entire training inference device 1000. The storage 1, the inputter 2, and the display 3 are each connected to the operator 4 via a bus 9, and communicate with the operator 4.

The storage 1 includes volatile memory and non-volatile memory, and stores programs and various types of data. The storage 1 is used as the working memory of the operator 4. The programs stored in the storage 1 include a training processing program 11 for realizing the various functions of a training device 100 (described later), and an inference processing program 12 for realizing the various functions of an inference device 200 (described later).

The inputter 2 includes a keyboard, a mouse, a touch panel, or the like. The inputter 2 detects input operations performed by the user and outputs, to the operator 4, signals representing the detected input operations performed by the user.

The display 3 includes a display, a touch panel, or the like. The display 3 displays images based on signals supplied from the operator 4.

The operator 4 includes a central processing unit (CPU). The operator 4 executes the various programs stored in the storage 1 to realize the various functions of the training inference device 1000. The operator 4 may include a processor dedicated to AI use.

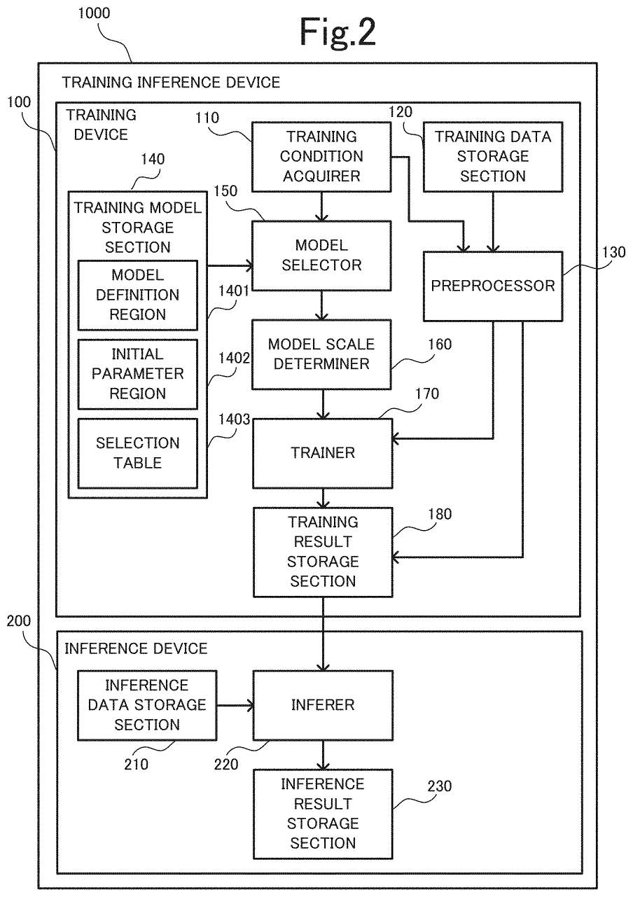

As illustrated in FIG. 2, the training inference device 1000 functionally includes a training device 100 that provides training data to the deep neural network and carries out training by deep learning, and an inference device 200 that inputs the data to be inferred (hereinafter sometimes referred to as “inference subject data”) into the trained deep neural network to perform inference.

In the present embodiment, the training device 100 selects, on the basis of information that indicates prerequisites and restrictions related to training that are input by the user, a learning model that serves as the framework of the pre-modified deep neural network, changes the selected learning model to a configuration that satisfies the prerequisites and restrictions of the training that are input by the user, and generates a deep neural network. Prior to the inference by the inference device 200, the training device 100 modifies the deep neural network by training using the training data.

As illustrated in FIG. 2, the training device 100 includes a training condition acquirer 110 that acquires training conditions input by the user, a training data storage section 120 that stores the training data, a preprocessor 130 that preprocesses the training data, a learning model storage section 140 that stores information about the learning model, a model selector 150 that selects the learning model in accordance with the training condition, a model scale determiner 160 that determines the scale of the learning model in accordance with the training conditions, a trainer 170 that performs training using the training data, and a training results storage section 180 that stores training results. The training condition acquirer 110 is an example of the training condition acquisition means of the present disclosure. The model selector 150 is an example of the learning model selection means of the present disclosure. The model scale determiner 160 is an example of the learning model scale determination means of the present disclosure. The trainer 170 is an example of the training means of the present disclosure. The operator 4 executes the training processing program 11 to realize the various constituents of the training device 100.

The training condition acquirer 110 acquires, from the input of the user received by the inputter 2, content of the training conditions representing the prerequisites and restrictions related to the training, and outputs the acquired content of the training conditions to the model selector 150. The prerequisites and restrictions input by the user include an inference purpose, restrictions on hardware resources, information representing the characteristics of the training data, and a target to be achieved in the training.

Next, the information that the training condition acquirer 110 receives from the user is described in detail.

The training condition acquirer 110 receives an input about the inference purpose from the user, and outputs, to the model selector 150, information indicating the purpose selected by the user. The inference purpose indicates the purpose of the inference to be performed by the inference device 200 (described later). The inference device 200 uses the deep neural network that is modified by the training device 100 and, as such, the training device 100 performs training that corresponds to the inference purpose specified by the user.

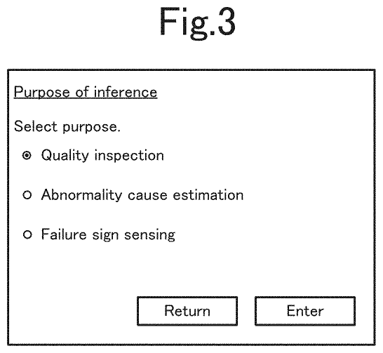

The training condition acquirer 110 displays an input screen such as illustrated in FIG. 3 on the display 3 in order to receive the input of the user about the inference purpose. In the example illustrated in FIG. 3, the user is presented with three options, namely “quality inspection”, “abnormality cause estimation”, and “failure sign sensing.” The user uses the inputter 2 to select the desired purpose. When “quality inspection” is selected, the user indicates a desire to determine quality by the inference of the inference device 200. When “abnormality cause estimation” is selected, the user indicates a desire to estimate the cause of an abnormality by the inference of the inference device 200. When “failure sign sensing” is selected, the user indicates a desire to predict the occurrence of a failure by the inference of the inference device 200.

The training condition acquirer 110 receives inputs about restrictions on hardware resources from the user. The restrictions on hardware resources indicate restrictions on hardware resource usable by the training inference device 1000 for the training of the training device 100.

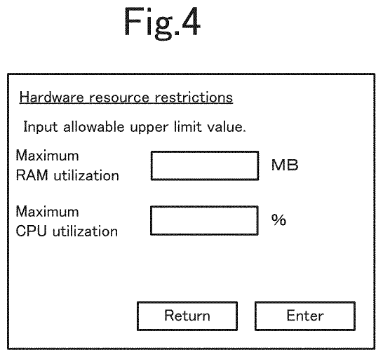

The training condition acquirer 110 displays an input screen such as illustrated in FIG. 4 on the display 3 in order to receive the input of the user about the restrictions on hardware resources. The user specifies, as a restriction on hardware resources, a memory capacity allowed to be used. An upper limit value of the memory capacity specified by the user is used to determine the scale of the deep neural network of the model scale determiner 160 (described later). The training condition acquirer 110 outputs, to the model selector 150, the upper limit value of the memory capacity input by the user. Furthermore, in the input screen illustrated in FIG. 4, the user specifies a processor utilization allowed to be used. The trainer 170 (described later) adjusts the load of the training processing in accordance with the processor utilization specified by the user.

The training condition acquirer 110 illustrated in FIG. 2 receives information indicating the characteristics of the training data from the user. In one example, the information indicating the characteristics of the training data includes the type of training data, a maximum value and a minimum value that constitute the range of possible values of the training data, information indicating whether the training data is time series data, and a number of pieces of data in one cycle when the training data is time series data. Note that the information indicating the characteristics of the training data may include only a part of that described above.

In the case of the present embodiment, the training data includes simple numerical data and data that is labeled. The data that is labeled (hereinafter referred to as “labeled data”) is data for which meanings represented by the possible values are defined.

The labeled data includes data defined for each value. For example, in order to indicate whether a switch is ON or OFF, “1” is associated with ON and “0” is associated with OFF. This definition is stored in advance in the storage 1. When defined in this manner, the value of the labeled data related to a switch in the training data is 1 or 0. In another example, in order to indicate ranges of air temperatures, “1” is associated with 1° C. to 20° C., “2” is associated with 20.1° C. to 30° C., and “3” is associated with 30.1° C. to 40° C. When defined in this manner, the value of the labeled data related to air temperature in the training data is 1, 2, or 3. The preprocessor 130, the model selector 150, and the trainer 170 handle each of the labeled data related to the switch and the labeled data related to the air temperature on the basis of information about the definitions stored in the storage 1.

The label may represent a characteristic of that value. For example, a “rotation speed” label may be attached to data obtained by measuring rotation speed. In this case, the value in the training data is any value obtained by measuring rotation speed. The preprocessor 130, the model selector 150, and the trainer 170 handle the data labeled with “rotation speed” as data obtained by measuring rotation speed.

As described above, the training data includes simple numerical data and labeled data. As such, the type of training data acquired by the training condition acquirer 110 includes information indicating if the training data is simple numerical data or is labeled data. Furthermore, when the training data is labeled data, the training condition acquirer 110 acquires a label name. For example, the label name is “switch”, “air temperature”, or “rotation speed.”

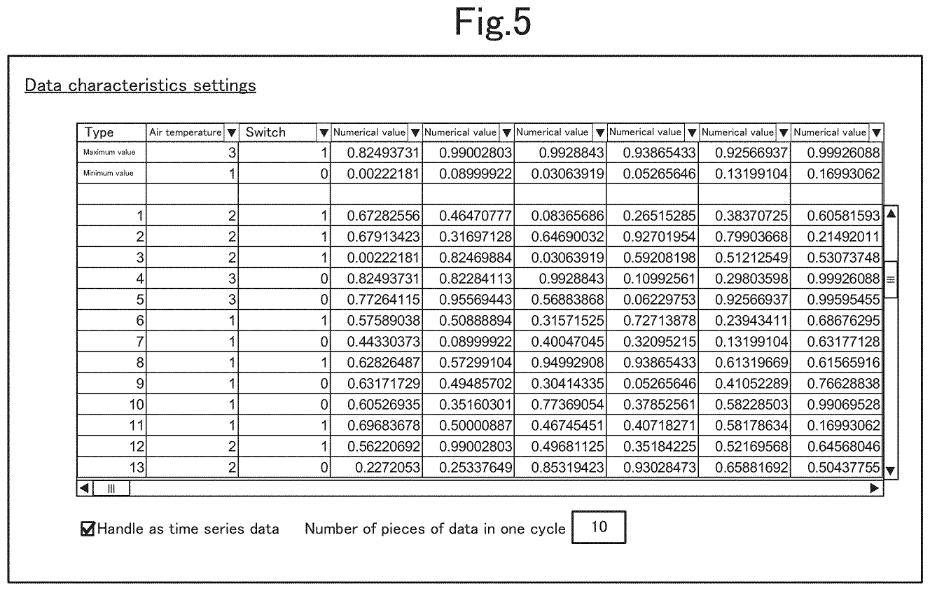

The training condition acquirer 110 displays an input screen such as illustrated in FIG. 5 on the display 3 in order to receive an input by the user about the type of the training data. In the example illustrated in FIG. 5, the training data stored in the training data storage section 120 is displayed and, also, the type of training data can be specified. In this case, one column of data is defined as one dimension of data. Accordingly, in the example illustrated in FIG. 5, the number of input dimensions is eight. One column of data is, for example, measurement values collected in a time series from a certain sensor.

In FIG. 5, “Numerical value” or the label name assigned that column of data is listed as the type of each column of data. In the example illustrated in FIG. 5, “Switch” and “Air temperature” are displayed as label names. The user operates the inputter 2 to select “Numerical value” or the desired label name as the type of each column of data. The model selector 150 (described later) modifies the learning model depending on whether the training data is labeled data or a numerical value.

Additionally, the range of possible values of the training data acquired by the training condition acquirer 110 is indicated by the maximum value and the minimum value of the training data. The maximum value of each column is the maximum value of the set of data of that dimension, and the minimum value of each column is the minimum value of the set of data of that matter. In one example, the maximum value and the minimum value are used when preprocessing. In the example illustrated in FIG. 5, the displayed values are minimum values and maximum values that the training condition acquirer 110 calculates in advance for each column of data. Note that the user can correct the maximum values and the minimum values. For example, the number of digits after the decimal point may be rounded off to a predetermined range.

Information indicating whether the training data acquired by the training condition acquirer 110 is time series data is also input via the screen illustrated in FIG. 5. The user specifies whether to handle the training data as time series data. Furthermore, when the training data is to be handled as time series data, the user inputs the number of pieces of data in one cycle.

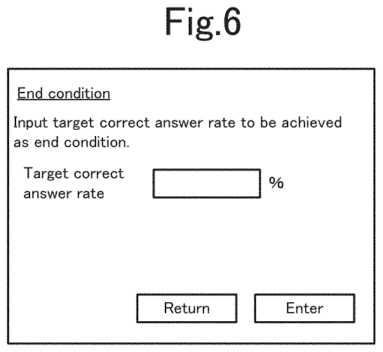

The training condition acquirer 110 illustrated in FIG. 2 receives, from the user, an input about a target correct answer rate that indicates the target to be achieved. In the present embodiment, the trainer 170 (described later) ends the training when the correct answer rate specified by the user is achieved by the training. In the present embodiment, the target correct answer rate represents a training end condition. The training condition acquirer 110 displays an input screen such as illustrated in FIG. 6 on the display 3, and receives the input of the target correct answer rate from the user.

The training data storage section 120 illustrated in FIG. 2 stores the training data. In one example, the training data is data collected over a given period in the past from various devices such as programmable logic controllers and intelligent functional units that operate in production systems, control systems, and the like, and sensors provided in facilities. Prior to the training, training data corresponding to the purpose, and corresponding correct answer data are each stored in the training data storage section 120. The correct answer data is a value expected as the output of the deep neural network when the training data is input into the deep neural network. The correct answer information is used in back propagation and calculation of the correct answer rate of the training. The correct answer data is an example of the correct answer value of the present disclosure.

Correct answer data used in training for the purpose of quality inspection is, for example, data collected at the time of manufacture of a part, and includes information indicating if the quality of that part passed or failed.

Correct answer data used in training for the purpose of abnormality cause estimation is, for example, data collected from a device that is operated at the time of occurrence of an abnormality, from a sensor provided on that device, or the like; and includes information indicating the cause of the occurrence of the abnormality.

Correct answer data used in training for the purpose of failure sign sensing is, for example, data collected from a device that operates, from a sensor provided on that device, or the like; and includes information indicating if an operating state of that device is normal or abnormal.

Alternatively, the correct answer data used in training for the purpose of failure sign sensing may, for example, consist only of data collected at the time of failure occurrence from the device that operates, the sensor provided on that device, or the like. In this case, the correct answer data includes information indicating a level, among a number of predefined levels representing degrees of failure, of the operating state of that device.

Prior to the training, the preprocessor 130 carries out preprocessing on the training data, and outputs the preprocessed data to the trainer 170. In one example, the preprocessing includes fast Fourier transformation, difference processing, logarithmic conversion, and differential processing. The preprocessor 130 carries out preprocessing corresponding to each individual piece of training data. For example, when the training data is a measured value of rotation speed, and is labeled data labeled with “rotation speed”, that data is subjected to frequency analysis by fast Fourier transformation. The preprocessor 130 stores information identifying the content of the preprocessing and the preprocessed data in the training results storage section 180. This is done to use the same preprocessing method in the inference device 200 (described later).

The learning model storage section 140 stores information related to a plurality of learning models. Specifically, the learning model storage section 140 includes a model definition region 1401 that stores equations expressing each of the learning models selectable by the model selector 150. The learning model storage section 140 further includes an initial parameter region 1402 that stores initial parameters of each of the learning models. The initial parameter region 1402 stores, for each of the pre-modified learning models, an initial value for the number of intermediate layers, an initial value for the number of nodes in each intermediate layer, an initial value for the number of nodes of the output layer, an initial value of a weighting applied to the input value of each node, and a training rate that indicates the updatable range of the weighting of each node. These initial values and training rates that are stored in the learning model storage section 140 may be defined for each of the plurality of learning models to be selected by the model selector 150 (described later). Note that, fundamentally, the number of nodes of the input layer of the deep neural network is set so as to be equivalent to the number of dimensions of the training data.

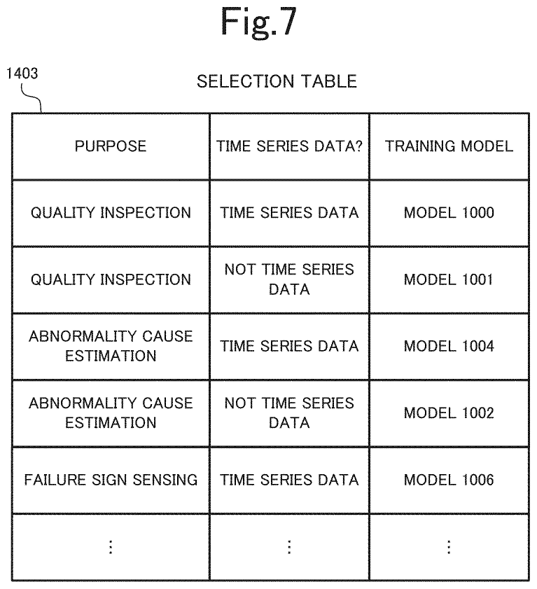

Furthermore, the learning model storage section 140 includes a selection table 1403 that the model selector 150 uses when selecting the learning model. As illustrated in FIG. 7, the selection table 1403 stores information that defines suitable learning models in accordance with the purpose and whether the data is time series data that is characteristic of the training data.

The model selector 150 illustrated in FIG. 2 selects, in accordance with the training conditions acquired by the training condition acquirer 110, a learning model that serves as the framework of the deep neural network.

In the present embodiment, the model selector 150 selects the learning model on the basis of the inference purpose, the characteristics of the training data, and the selection table 1403 illustrated in FIG. 7. For example, when the inference purpose is “quality inspection” and the training data is specified as time series data, “Model 1000” from the selection table 1403 matches as the learning model. In this case, the model selector 150 selects “Model 1000” as the learning model.

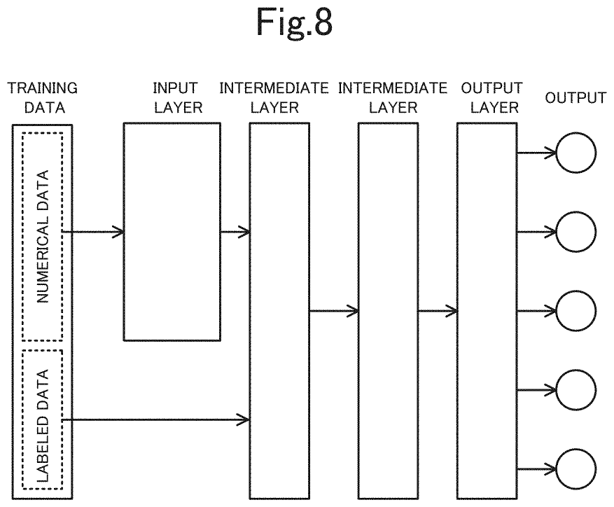

Furthermore, the model selector 150 changes the configuration of the learning model in accordance with the type of training data input by the user. For example, as illustrated in FIG. 8, the model selector 150 changes the learning model such that the labeled data of the training data is not input into the input layer and is directly input into the intermediate layers. The model selector 150 outputs, to the model scale determiner 160, information identifying the selected and changed learning model. Additionally, the model selector 150 stores the information identifying the learning model in the training results storage section 180.

The model scale determiner 160 determines the scale of the learning model in accordance with the training conditions acquired by the training condition acquirer 110. In the present embodiment, for the learning model selected by the model selector 150, the model scale determiner 160 increases or decreases the number of intermediate layers, increases or decreases the number of nodes in each intermediate layer, and determines whether to provide a connection between nodes on the basis of the restrictions on hardware resources specified by the user. For example, when the scale of the intermediate layers increases, the model scale determiner 160 sets the connections between a portion of the nodes to null. The speed of computation can be increased by setting the connections between a portion of the nodes to null in this manner.

In one example, when the target correct answer rate input by the user in the screen illustrated in FIG. 6 is greater than or equal to a predetermined value, the model scale determiner 160 increases the number of intermediate layers beyond the initial value and increases the number of nodes in each intermediate layer beyond the initial value, thereby expanding the scale of the learning model. Alternatively, the model scale determiner 160 may increase only one of the number of intermediate layers and the number of nodes in each intermediate layer. Additionally, when the upper value of the memory capacity input by the user in the screen illustrated in FIG. 4 is less than or equal to a predetermined value, the model scale determiner 160 decreases the number of intermediate layers to less than the initial value and decreases the number of nodes in each intermediate layer to less than the initial value, thereby shrinking the scale of the learning model. Alternatively, the model scale determiner 160 may decrease only one of the number of intermediate layers and the number of nodes in each intermediate layer. The amount of memory utilization by the neural network when training can be suppressed by decreasing the number of intermediate layers and decreasing the number of nodes in each intermediate layer in this manner.

The model scale determiner 160 outputs the learning model, which is changed to the determined scale, to the trainer 170. Additionally, the model scale determiner 160 stores, in the training results storage section 180, the changed number of intermediate layers and the changed number of nodes in each intermediate layer as information indicating the determined scale of the learning model.

The trainer 170 inputs the preprocessed training data supplied from the preprocessor 130 into the deep neural network that uses the learning model output by the model scale determiner 160 to carry out the training. The trainer 170 inputs the training data into the deep neural network and appropriately updates the weighting of each of the nodes by back propagation so that the output value approaches the correct answer data stored in the training data storage section 120.

Additionally, the trainer 170 consecutively calculates the correct answer rate from the difference between the output of the deep neural network and the correct answer information in order to determine the training end condition. The trainer 170 ends the training when the calculated correct answer rate reaches the correct answer rate specified by the user. The trainer 170 stores the modified weighting of each node of the deep neural network in the training results storage section 180 as training results. Additionally, the trainer 170 carries out training processing while monitoring the load on the operator 4 so as not to exceed the processor utilization specified by the user in the screen illustrated in FIG. 4.

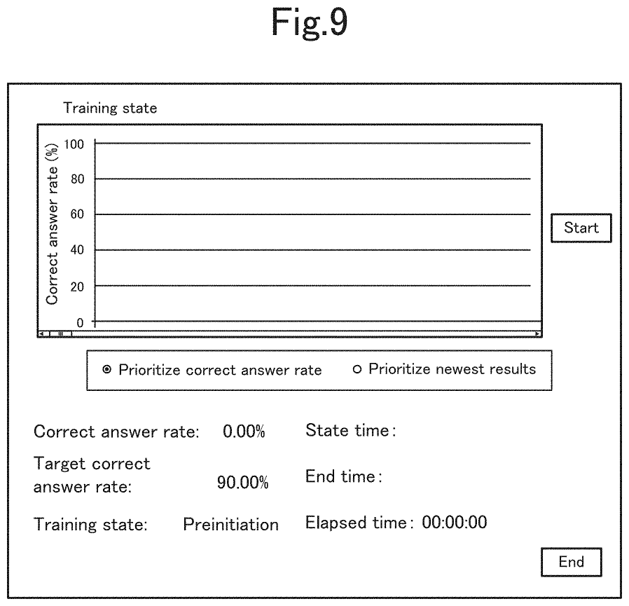

The trainer 170 displays a screen indicating progress such as illustrated in FIGS. 9 to 11 on the display 3 in order to present the progress of the training. As illustrated in FIGS. 9 to 11, as the final training results, the user can select to use training results that prioritize high correct answer rates or the newest training results. This is because, in deep learning, while the correct answer rate increases as the training progresses, there is vertical fluctuation. When, at the end of training. “prioritize correct answer rate” is selected, the trainer 170 stores, in the training results storage section 180, the weighting of each node from when the correct answer rate is highest. When, at the end of training, “prioritize newest results” is selected, the trainer 170 stores, in the training results storage section 180, the newest weighting of each node as the training results.

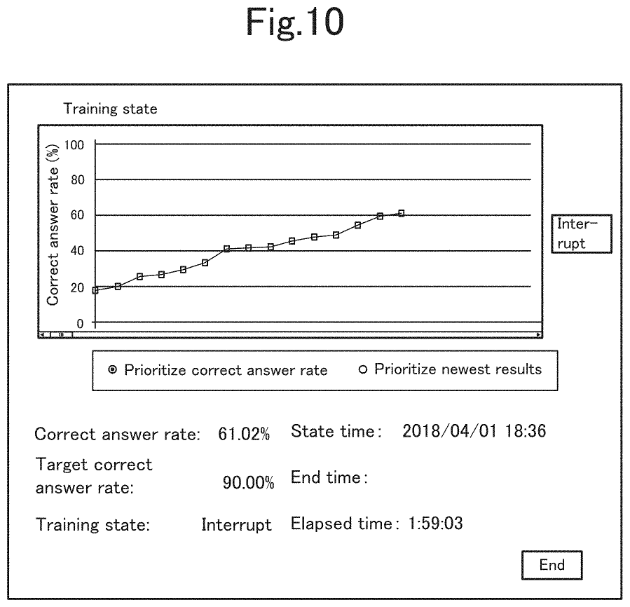

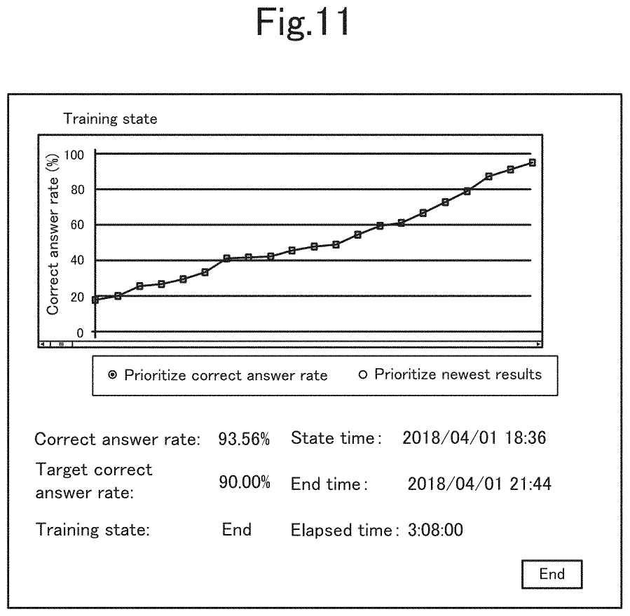

The trainer 170 starts, interrupts, and restarts the training in accordance with commands from the user. FIG. 9 is a screen that illustrates the progress before the start of training. When the user presses a start button, the trainer 170 starts the training, and displays a screen illustrating the progress, such as that illustrated in FIG. 10, on the display 3. The trainer 170 updates, at predetermined time intervals, the display content on the screen that illustrates the progress so that the newest progress is displayed. When the user presses an interrupt button, the trainer 170 interrupts the training. When the user instructs a restart by pressing a restart button, the trainer 170 restarts the training. When the training ends, the trainer 170 displays a screen such as illustrated in FIG. 11 on the display 3.

The training results storage section 180 stores the final weighting of each node of the deep neural network as the training results of the trainer 170. The configuration of the training device 100 is described above.

Next the inference device 200 illustrated in FIG. 2 is described. The inference device 200 uses the learning model modified by the training device 1 to perform inference for the inference subject data. The inference device 200 includes an inference data storage section 210 that stores the inference subject data an inferer 220 that uses the data to be inferred to perform inference, and an inference results storage section 230 that stores the results of the inference. The various constituents of the inference device 200 are realized as a result of the operator 4 executing the inference processing program 12.

The inference data storage section 210 stores the inference subject data.

Prior to the inference, the inferer 220 reads, from the training results storage section 180, the preprocessing method that the preprocessor 130 performs on the training data, and preprocesses the inference subject data.

After the preprocessing, the inferer 220 inputs, on the basis of the information stored in the training results storage section 180, the inference subject data into the modified deep neural network, and outputs an output value to the inference results storage section 230. During the execution of the inference as well, the inferer 220 displays a screen indicating progress on the display 3, similar to the progress when training illustrated in FIGS. 9 to 11.

The inference results storage section 230 stores the inference results of the inferer 220. Specifically, the inference results storage section 230 stores inference results based on the output of the deep neural network. The configuration of the inference device 200 is described above.

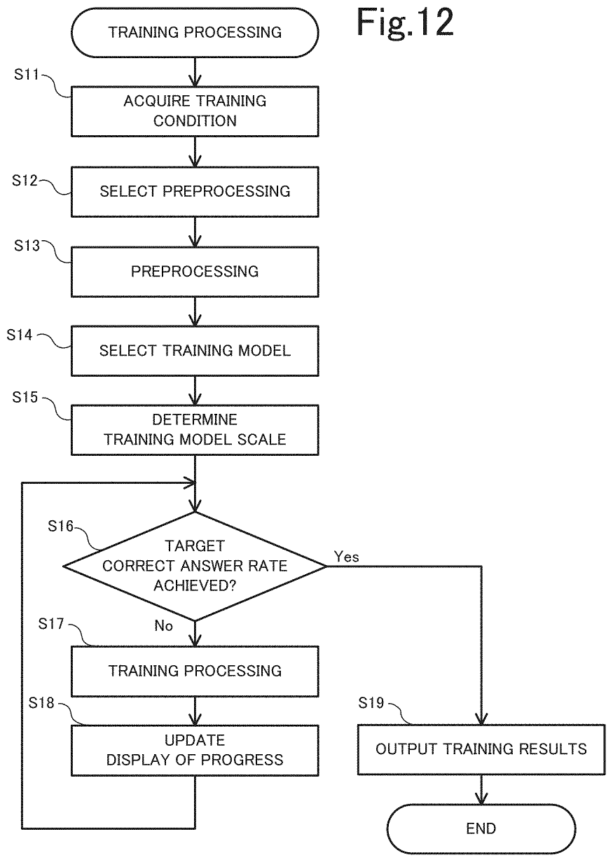

Next, the flow of training processing of the training device 100 is described while referencing FIG. 12. First, the training condition acquirer 110 acquires the training conditions indicating the prerequisites and the restrictions of the training input by the user via the screens illustrated in FIGS. 3 to 6 (step S11), and supplies the acquired training conditions to the preprocessor 130 and the model selector 150.

The preprocessor 130 selects the preprocessing method according to the training conditions supplied from the training condition acquirer 110 and the training data stored in the training data storage section 120 (step S12). The preprocessor 130 uses the selected preprocessing method to preprocess the training data stored in the training data storage section 120 (step S13), and supplies the preprocessed training data to the trainer 170. Additionally, the preprocessor 130 stores the preprocessing method that is used in the training results storage section 180.

The model selector 150 selects the learning model from the learning model storage section 140 in accordance with the training conditions supplied from the training condition acquirer 110 and the training data stored in the training data storage section 120 (step S14). Furthermore, the model selector 150 changes the configuration of the selected learning model in accordance with the type of the training data, and supplies information identifying that learning model to the model scale determiner 160.

The model scale determiner 160 determines, in accordance with the training condition supplied from the training condition acquirer 110, the scale of the learning model selected by the model selector 150 (step S15), and supplies the determined content to the trainer 170.

Until the target correct answer rate specified by the user is reached (step S16; No), the trainer 170 performs the training processing (step S17). Specifically, the trainer 170 inputs the training data into the deep neural network that uses the configuration determined by the model selector 150 and the model scale determiner 160, and calculates the correct answer rate from the correct answer data and the output of the deep neural network. The trainer 170 updates the display of the screen with the current training progress and the newest correct answer rate (step S18).

When the target correct answer rate specified by the user is reached (step S16; Yes), the trainer 170 ends the training and outputs the training results that include the weighting of each node (step S19). The flow of the training processing of the training device 100 is described above.

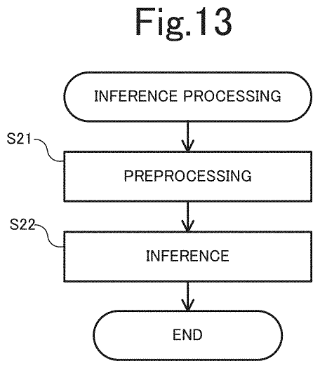

Next, inference processing of the inference device 200 using the trained deep neural network is described while referencing FIG. 13.

The inferer 220 reads, from the training results storage section 180, the preprocessing method that the preprocessor 130 performed on the training data, and performs preprocessing on the inference subject data stored in the inference data storage section 210 (step S21).

After the preprocessing, the inferer 220 reads, from the training results storage section 180, the information identifying the learning model selected by the model selector 150, the information identifying the scale determined by the model scale determiner 160, and the weightings of the deep neural network updated by the trainer 170. The inferer 220 inputs the inference subject data into the deep neural network that uses the read content, and executes the inference (step S22). The inferer 220 stores the inference results in the inference results storage section 230. The inference processing is described above.

As described above, in the present embodiment, the training device 100 automatically optimizes the learning model by selecting an appropriate learning model and determining the scale of the selected learning model in accordance with prerequisites and restrictions related to training that are specified by the user. As a result, the need for the user to select the learning model and determine of the scale of the learning model, which are tasks conventionally performed by the user, is eliminated. Therefore, deep learning can be easily performed even when the user is not especially knowledgeable.

The model scale determiner 160 modifies the scale of the learning model in accordance with the restrictions on hardware resources specified by the user. As such, when, for example, another application is running on the training device 100, the training can be executed without interfering with the running of the other application.

Since the model scale determiner 160 appropriately modifies the scale of the learning model, training in which a large-scale neural network is used for uncomplicated training data is avoided. Additionally, the training device 100 does not perform training using a small-scale neural network for complex training data. Due to this configuration. disadvantages such as unnecessary time use and unnecessary increases in processing loads on the processor, resulting from performing training using large-scale neural networks on uncomplicated training data without modifying the scale, are avoided. Additionally, disadvantages such as not obtaining satisfactory training results, resulting from performing training using small-scale neural networks on complex training data without modifying the scale, are avoided.

Furthermore, the model selector 150 may change the configuration of the learning model in accordance with the type of training data input by the user. For example, the model selector 150 may change the learning model so that labeled data is input directly into the intermediate layers without being input into the input layer. This is because the input training data is standardized in the input layer and, in this case, since the definitions of the various values are defined in advance in the labeled data, it is possible to omit standardization processing.

In the present embodiment, an example is described in which the model scale determiner 160 expands or shrinks the scale of the learning model in accordance with the memory capacity specified by the user as the restriction on hardware resources. However, the method of expanding or shrinking the scale of the learning model is not limited thereto.

For example, the model scale determiner 160 may expand or shrink the scale of the learning model in accordance with the number of dimensions of the input training data. Additionally, the model scale determiner 160 may expand or shrink the scale of the learning model in accordance with the degree of complexity of the training data. For example, when the training data is complex data, the scale of the learning model may be expanded and, when the training data is not complex, the scale of the learning model may be shrunk. The degree of complexity of the training data can be calculated, for example, by acquiring the average, variation, or other statistical quantity of the training data.

Additionally, the model scale determiner 160 can expand or shrink the scale of the learning model in accordance with the characteristics of the training data. For example, the scale of the learning model can be expanded or shrunk in accordance with whether the training data is temporally continuous data, or whether the training data has relevancy in a time series. For example, when the training data is temporally continuous data or has relevancy in a time series, one cycle of the data must be collectively input into the neural network. In this case, the number of input dimensions of the neural network increases. As a result, the scale of the neural network expands.

Additionally, the model scale determiner 160 can expand or shrink the scale of the learning model in accordance with the data type of the training data. This is because the structure of the neural network differs depending on the data type of the training data, which results in the scale of the neural network expanding or shrinking. Here, the types of data include numerical values, labeled data, and the like.

In the embodiment, the selection of the learning model and the determination of the scale are performed in accordance with the information indicating the inference purpose, the restrictions on hardware resources, the characteristics of the training data, and the target to be achieved that are input as the training conditions. However, it is possible to use only a portion of these as the training conditions. For example, the user may input only the inference purpose as the training condition, and the training device 100 may select the model and determine the scale in accordance with the input inference purpose.

The method of selecting the model is not limited to the method described in the embodiment. In one example, the learning model storage section 140 stores an evaluation value obtained by evaluating, in advance, the performance of each learning model. In a case in which, based on the inference purpose and the characteristics of the training data input by the user, there are a plurality of matching learning models in the selection table 1403, the model selector 150 selects the learning model on the basis of a target value to be achieved input by the user and the evaluation values indicating the performance of each of the matching learning models. When the target value to be achieved, namely the target correct answer rate, is greater than or equal to a predetermined value, the model selector 150 may select the learning model for which the evaluation value that represents performance is high.

A configuration is possible in which the training device 100 does not use the training conditions related to the selection and the scale of the model that are input by the user via the training condition input screens. For example, a file indicating conditions specified by the user may be stored in advance in the storage 1, and this file may be read out to perform the selection of the model and the determination of the scale in accordance with the training conditions.

In the embodiment, an example is described in which the training inference device 1000 includes the training device 100 and the inference device 200. However, a configuration is possible in which the training device 100 and the inference device 200 are separate devices.

In the embodiment, an example is described in which the training data is stored in advance in the training data storage section 120. However, the location where the training data is stored is not limited thereto. For example, a configuration is possible in which the training device 100 is provided with a network interface that enables communication with other devices, and the training data is provided from another device that is connected to the training device 100 via a network.

Likewise, a configuration is possible in which the inference subject data is provided to the inference device 200 from another device via a network. Additionally, a configuration is possible in which the inference device 200 processes inference subject data supplied in real-time and outputs inference results in real-time.

A computer-readable non-transitory recording medium such as a magnetic disk, an optical disk, a magneto-optical disk, a flash memory, a semiconductor memory. and a magnetic tape can be used as a recording medium on which the programs for the training processing and the inference processing in accordance with the embodiment described above.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Storage
2 Inputter
3 Display
4 Operator
9 Bus
11 Training processing program
12 Inference processing program
100 Training device
110 Training condition acquirer
120 Training data storage section
130 Preprocessor
140 Learning model storage section
150 Model selector
160 Model scale determiner
170 Trainer
180 Training results storage section
200 Inference device
210 Inference data storage section
220 Inferer
230 Inference results storage section
1000 Training inference device
1401 Model definition region
1402 Initial parameter region
1403 Selection table

1. A training device for performing training using a neural network, the training device comprising:
a training condition acquirer to acquire a prerequisite and a restriction of the training as a training condition, the prerequisite and the restriction of the training including a purpose of an inference performed using the trained neural network, a restriction on a hardware resource of the training device, information indicating a characteristic of training data, and a set target;
a learning model selector to select, in accordance with the prerequisite and the restriction of the training, a learning model that serves as a framework of a structure of the neural network;
a learning model scale determiner to determine,
in accordance with the prerequisite and the restriction of the training, a scale of the neural network for the selected learning model; and
a trainer to perform the training by inputting training data into the neural network in which the learning model is configured to the scale.

2. (canceled)

3. The training device according to claim 1, wherein
the scale is indicated by the number of intermediate layers of the neural network, the number of nodes included in each of the intermediate layers, and a presence of each of connections between the nodes, and
the learning model scale determiner, in accordance with the prerequisite and the restriction of the training, increases or decreases the number of intermediate layers of the neural network expressed by the learning model selected by the learning model selector, increases or decreases the number of nodes included in each of the intermediate layers, and determines the presence of each of the connections between the nodes.

4. (canceled)

5. The training device according to claim 1, wherein the learning model scale determiner determines the scale in accordance with the restriction on the hardware resource.

6. The training device according to claim 5, wherein the restriction on the hardware resource includes an upper limit value of a memory capacity usable in the training in the training device.

7. The training device according to claim 1, wherein the learning model selector selects the learning model in accordance with the purpose of the inference, and the information indicating the characteristic of the learning model.

8. The training device according to claim 1, wherein the information indicating the characteristic of the training data includes a type of the training data and a range of possible values of the training data.

9. The training device according to claim 8, wherein the learning model selector changes, in accordance with the type of the training data, a configuration of the selected learning model such that the training data is input into a specified intermediate layer of the neural network without being input into an input layer of the neural network.

10. The training device according to claim 1, wherein
the trainer calculates a correct answer rate from a difference between a correct answer value that is a true value to be output by the neural network into which the training data is input, and an output value output by the neural network when the training data is actually input, and
the set target indicates the correct answer rate to be achieved in the training of the trainer.

11. The training device according to claim 1, wherein the training condition acquirer acquires the training condition that is input by a user.

12. The training device according to claim 1, further comprising:
a preprocessor to perform preprocessing suited to the training data prior to the training of the trainer.

13. The training device according to claim 1, wherein the trainer updates, by the training, a weighting of each of the nodes included in the intermediate layers of the neural network, and outputs the neural network for which the weightings are updates as a trained neural network.

14. A training inference device comprising:
the training device according to claim 13, wherein
data to be inferred is input into the trained neural network output by the trainer, and an output of the trained neural network is set as an inference result.

15. A method executable by a computer configured to perform training using a neural network, the method comprising:
acquiring a prerequisite and a restriction of the training as a training condition, the prerequisite and the restriction of the training including a purpose of an inference performed using the trained neural network, a restriction on a hardware resource of the computer, information indicating a characteristic of training data, and a set target;
selecting a structure of the neural network in accordance with the prerequisite and the restriction of the training;
determining a scale of the neural network in accordance with the prerequisite and the restriction of the training; and
performing training by inputting the training data into the neural network that has the selected structure and the determined scale.

16. A non-transitory computer-readable recording medium storing a program, the program causing a computer configured to perform training using a neural network to:
acquire a prerequisite and a restriction of the training as a training condition the prerequisite and the restriction of the training including a purpose of an inference performed using the trained neural network, a restriction on a hardware resource of the computer, information indicating a characteristic of training data, and a set target;
select, in accordance with the prerequisite and the restriction of the training, a learning model that serves as a framework of a structure of the neural network;
determine, in accordance with the prerequisite and the restriction of the training, a scale of the neural network for the learning model; and
perform the training by inputting training data into the neural network in which the learning model is configured to the scale.
